(19) United States
(12) Patent Application Publication
(10) Pub. No.: US 2002/0004083 A1
(43) Pub. Date: Jan. 10, 2002

(54) Controlled release perillartine in chewing gum

(75) Inventors: Robert J. Yatka, Orland Park, IL (US); Gordon N. McGrew, Evanston, IL (US); Sonya S. Johnson, LaGrange Highlands, IL (US); David G. Barkalow, Deerfield, IL (US); Philip W. Urnezis, Lombard, IL (US); Philip Mazzone, Griffith, IN (US); Michael J. Greenberg, Northbrook, IL (US)

Correspondence Address: BRINKS HOFER GILSON & LIONE, P.O. BOX 10395, CHICAGO, IL, 60610, US

(73) Assignee: Wm. Wrigley Jr. Company

(21) Appl. No.: 09/751,065

(22) Filed: Dec. 28, 2000

Related U.S. Application Data
(60) Provisional application No. 60/173,729, filed on Dec. 30, 1999.

(51) Int. Cl. A23G 3/30

(52) U.S. Cl. 426/5

(57) ABSTRACT

Perillartine is used to sweeten chewing gum in a manner that gives a modified release of the perillartine. The perillartine may be encapsulated, partially encapsulated, partially coated, entrapped or absorbed. It my be used in a chewing gum coating, as a dusting agent or in a centerfill of a liquid-center gum. It may be codried with other sweeteners, or subject to a combination of the foregoing steps in order to modify its release from chewing gum.

### REFERENCE TO EARLIER FILING APPLICATION

The present application claims benefit of the filing date under 35 U.S.C. § 119(e) of Provisional Application Ser. No. 60/173,729, filed Dec. 30, 1999, which is incorporated herein by reference.

### BACKGROUND OF THE INVENTION

The present invention relates to chewing gum compositions and methods of making such composition. More particularly, the invention relates to the use of a high intensity sweetener, perillartine, which has been treated or incorporated in the chewing gum product so as to have a modified release from the chewing gum during chewing.

Perillartine is an organic soluble sweetener. U.S. Pat. No. 3,608,069 to Fuller discloses a soliloquy composition for oral preparations that includes perillartine as a sweetener and methylene chloride as a flavoring agent. U.S. Pat. No. 3,699,132 discloses 8,9 epoxy perillartine isomers having a good sweetness and no or moderately low bitter aftertaste characteristics. The incorporation of perillartine into a chewing gum composition is disclosed in PCT Patent Publication No. WO 98/18340.

Perillartine gives the chewing gum composition an improved sweetness and prolonged sweetness duration, and unexpected oral trigeminal effects.

It would be an improvement if the rate at which perillartine released from chewing gum composition during chewing could be modified so that the sensory perceptions from the use of perillartine could be changed, such as to achieve a faster release or a longer lasting sweetness.

### SUMMARY OF THE INVENTION

The present invention includes a method for producing a chewing gum with a modified high-intensity sweetener, specifically perillartine. The controlled release, high-intensity sweetener is obtained by modifying the sweetener by encapsulation, partial encapsulation or partial coating, entrapment or absorption with water-soluble materials or water-insoluble materials. The procedures for modifying the sweetener include spray drying, spray chilling, fluid-bed coating, coacervation, and other agglomerating and standard encapsulating techniques. The sweetener may also be absorbed onto an inert or water-insoluble material. The sweetener may be modified in a multiple step process comprising any of the processes or combination of processes noted. The sweetener, perillartine, may also be combined with other sweeteners including but not limited to sucrose, dextrose, fructose, maltose, maltodextrin, xylose, palatinose, or others that are considered bulk sweeteners, as well as sugar alcohols including but limited to sorbitol, mannitol, xylitol, maltitol, lactitol, hydrogenated isomaltulose, and hydrogenated starch hydrolysates. The high-intensity sweetener may also be combined with other high-intensity sweeteners including but not limited to aspartame, acesulfame K, saccharin, sucralose, alitame, cyclamate, stevioside, and glycyrrhizin.

This sweetener, perillartine, when modified according to the present invention, gives a chewing gum having a controlled-release sweetener. A higher quality of sweetener can be used having a controlled sweetness release that is compatible with flavor release in chewing gum, giving a highly consumer-acceptable chewing gum product.

### DETAILED DESCRIPTION OF THE INVENTION AND PREFERRED EMBODIMENTS

Perillartine is a high-intensity sweetener, reported to be up to 2000 times sweeter than sucrose. The taste properties are considered good. It is slightly bitter, has a menthol-licorice character and has very low water solubility. Due to these characteristics, it would be considered a significant improvement to a chewing gum to have the perillartine sweetener release its sweetness more quickly in the early stages of the chew when flavor is released. In other cases, a slow release may be desired during the chew, to balance the overall taste perception. This would also slow the release of the menthol/licorice aftertaste, so that more sweetener could be used without a significant aftertaste. Physical modifications of this sweetener may also improve its stability in the final product. Perillartine will preferably be used at a level of between about 1 ppm and 5000 ppm in chewing gum formulations of the present invention.

As stated previously, perillartine releases slowly from chewing gum during the early stages of mastication because of its low solubility in water. Physical modifications of the sweetener by encapsulation with another substrate will increase its release in chewing gum by increasing the solubility or dissolution rate of perillartine. Also, some modifications may make the perillartine solubility even lower so that its release rate in chewing gum would be even more delayed. Any standard technique which gives partial or full encapsulation of the perillartine sweetener can be used. These techniques include, but are not limited to, spray drying, spray chilling, fluid-bed coating, and coacervation. These encapsulation techniques that give partial encapsulation or full encapsulation can be used to individually or in any combination in a single step process or multiple step process. Generally, more delayed release of sweetener is obtained in multi-step processes like spray drying the sweetener and then fluid-bed coating of the resultant powder. Generally, fast release sweetener is obtained by a single step like spray drying the sweetener with water-soluble materials.

The encapsulation techniques here described are standard coating techniques and generally give varying degrees of coating, from partial to full coating, depending on the coating composition used in the process. Also, the coating compositions may be susceptible to water permeation to various degrees. Generally, compositions having high organic solubility, good film-forming properties, and low water solubility give better delayed release of the sweetener. Such compositions include acrylic polymers and copolymers, carboxyvinyl polymer, polyamides, polystyrene, polyvinyl acetate, polyvinyl acetate pthlalate, polyvinylpyrrolidone, and waxes. Although all of these materials are possible for encapsulation of the perillartine sweetener, only food grade materials should be considered. Two standard food grade-coating materials that are good film formers but are not water-soluble are shellac and zein. Others that are more water soluble, but good film formers, are materials like agar, alginates, a wide range of cellulose derivatives like ethyl cellulose, methyl cellulose, sodium hydroxymethyl cellulose, and hydroxypropylmethyl cellulose, dextrin, gelatin, and modified starches. These ingredients, which are generally approved for food use, also give a modified release when used as an encapsulant for perillartine. Other encapsulants like acacia or maltodextrin can also encapsulate perillartine, and give a very fast release rate of perillartine in gum.

The amount of coating or encapsulation material on the sweetener perillartine also controls the length of time for its release from chewing gum. Generally, the higher the level of coating and the lower the amount of active perillartine, the slower the release of sweetener during mastication. The release is generally not instantaneous, but gradual over an extended period of time. To obtain the desired sweetness release to blend with a gum's flavor release, the encapsulant should be a minimum of about 20% of the coated sweetener. Typically, the encapsulant should be a minimum of about 30% of the coated sweetener, or could be a minimum of about 40% of the coated sweetener. Depending on the coating material, a higher or lower amount of coating material may be needed to give the desired release of sweetener to balance sweetness release with flavor release.

Another method of giving a delayed release of the sweetener, perillartine, is an agglomeration of the sweetener with an agglomerating agent which partially coats the sweetener. This method includes the step of mixing the sweetener and agglomerating agent with a small amount of water or solvent. The mixture is prepared in such a way as to have individual wet particles in contact with each other so that partial coating can be applied. After the water or solvent is removed, the mixture is ground and used as a powdered, coated sweetener.

Materials that can be used as the agglomerating agent are the same as those used in the encapsulation procedures mentioned previously. However, since the coating is only a partial encapsulation and the perillartine sweetener is very slightly water soluble, some agglomerating agents are more effective in modifying the sweetener release than others. Some of the better agglomerating agents are the organic polymers like acrylic polymers and copolymers, polyvinyl acetate, polyvinylpyrrolidone, waxes, shellac, and zein. Other agglomerating agents are not as effective in giving the sweetener a delayed release as are the polymers, waxes, shellac, and zein, but can be used to give some delayed release. These other agglomerating agents include, but are not limited to, agar, alginates, a wide range of cellulose derivatives like ethyl cellulose, methyl cellulose, sodium hydroxymethyl cellulose, hydroxypropylmethyl cellulose, dextrin, gelatin, modified starches, and vegetable gums like guar gums, locust bean gum, and carrageenin. Agglomerating agents like maltodextrin or acacia can be used to increase the rate of sweetener release. Even though the agglomerated sweetener is only partially coated, when the quantity of coating is increased compared to the quantity of the perillartine sweetener, the release of the sweetener can be increased or delayed for a longer time during mastication. The level of coating used in the agglomerated product is a minimum of about 5%. The coating level could be a 15% or even 20%. Depending on the agglomerating agent, a higher or lower amount of agent may be needed to give the desired release of sweetener to balance sweetness release with flavor release.

The perillartine sweetener may be coated in a two-step process or multiple step process. The sweetener may be encapsulated with any other materials as described previously and then the encapsulated sweetener can be agglomerated as described previously to obtain an encapsulated/agglomerated/sweetener product that could be used in chewing gum to give a more modified release of sweetener.

In another embodiment of this invention, perillartine sweetener may be absorbed onto another component that is porous and become entrapped in the matrix of the porous component. Common materials used for absorbing the sweetener include, but are not limited to, silicates, pharmasorb clay, spongelike beads or microbeads, amorphous carbonates and hydroxides, including aluminum and calcium lakes, vegetable gums, and other spray dried materials.

Depending on the type of absorbent material and how it is prepared, the amount of the perillartine sweetener that can be loaded onto the absorbent will vary. Generally materials like polymers or sponglike beads or microbeads, amorphous sugars and alditols and amorphous carbonates and hydroxides absorb an amount equal to about 10% to 40% of the weight of the absorbent. Other materials like silicas and pharmasorb clays may be able to absorb about 20% to 80% of the weight of the absorbent.

The general procedure for absorbing the sweetener onto the absorbent is as follows. An absorbent like fumed silica powder can be mixed in a powder blender and an aqueous solution of the perillartine sweetener can be sprayed onto the powder as mixing continues. The aqueous solution can be about 0.1% to 1.0% perillartine solids, and higher solid levels may be used if temperatures up to 150° C. are used. Solvents like alcohol can be used if food approved. As the powder mixes, the liquid is sprayed onto the powder. Spraying is stopped before the mix becomes damp. The still free-flowing powder is removed from the mixer and dried to remove the water or other solvent, and then ground to a specific particle size.

After perillartine is absorbed onto an absorbent or fixed onto an absorbent, the fixative/sweetener can be coated by encapsulation. Either full or partial encapsulation may be used, depending on the coating composition used in the process. Full encapsulation may be obtained by coating with a polymer as in spray-drying, spray-chilling, fluid-bed coating, coacervation, or any other standard technique. A partial encapsulation or coating can be obtained by agglomeration of the fixative/sweetener mixture using any of the materials discussed above.

Another form of encapsulation is by entrapment of an ingredient by fiber extrusion or fiber spinning into a polymer. Polymers that can be used for extrusion are PVAC, hydroxypropyl cellulose, polyethylene, and other types of plastic polymers. A process of encapsulation by fiber extrusion is disclosed in U.S. Pat. No. 4,978,537, which is hereby incorporated by reference. The water insoluble polymer may be preblended with perillartine prior to fiber extrusion, or may be added after the polymer is melted. As the extrudate is extruded, it results in small fibers that are cooled and ground. This type of encapsulation/entrapment generally gives a very long, delayed release of an active ingredient.

The four methods of use to obtain a controlled release of the perillartine sweetener are:

Encapsulation by spray-drying, fluid-bed coating, spray-chilling, and coacervation to give full or partial encapsulation.

Agglomeration to give partial encapsulation.

Fixation or entrapment/absorption which also gives partial encapsulation.

Entrapment into an extruded compound

These four methods, combined in any usable manner that physically isolates the perillartine sweetener, reduces or increases its dissolvability or modifies the release of sweetener, are included in this invention.

Other methods of treating the perillartine sweetener to physically isolate the sweetener from other chewing gum ingredients may also have some effect on its release rate and stability. The perillartine sweetener may be added to the liquid inside a liquid center gum product. The center fill of gum product may comprise one or more carbohydrate syrups, glycerin, thickeners, flavors, acidulants, colors, sugars and sugar alcohols in conventional amounts. The ingredients are combined in a conventional manner. The perillartine sweetener is dissolved in the center-fill liquid and the amount of the perillartine sweetener added to the center-fill liquid is about 10 ppm to approximately 500 ppm by weight of the entire chewing gum formula. This method of using perillartine in chewing gum can allow a lower usage level of the sweetener, can give the sweetener a more controlled release rate, and can reduce or eliminate any possible reaction of the sweetener with gum base, flavor components, or other components, yielding improved shelf stability.

Another method of isolating perillartine sweetener from other chewing gum ingredients is to add perillartine to the dusting compound of a chewing gum. A rolling or dusting compound serves to reduce sticking to machinery as it is wrapped, and sticking to its wrapper after it is wrapped and being stored. The rolling compound comprises perillartine sweetener in combination with mannitol, sorbitol, sucrose, starch, calcium carbonate, talc, other orally acceptable substances or a combination thereof. The rolling compound constitutes from about 0.25% to about 10.0%, or about 1% to about 3% of weight of the chewing gum composition. The amount of perillartine sweetener added to the rolling compound is about 0.1 ppm to about 100 ppm of the chewing gum composition. This method of using perillartine sweetener in the chewing gum can allow a lower usage level of the sweetener, can give the sweetener a more controlled release rate, and can reduce or eliminate any possible reaction of the sweetener with the gum base, flavor components, or other components, yielding improved shelf stability.

Another method of isolating perillartine sweetener is to use it in the coating/panning of a pellet chewing gum. Pellet or ball gum is prepared as conventional chewing gum but formed into pellets that are pillow shaped, or into balls. The pellets/balls can be then sugar coated or panned by conventional panning techniques to make a unique coated pellet gum. The perillartine sweetener is soluble in flavor and can be added to the coating with the flavor or blended with other powders often used in some types of conventional panning procedures. Using perillartine isolates the sweetener from other gum ingredients and modifies its release rate in chewing gum. Levels of using perillartine may be about 10 ppm to 2,000 ppm by weight of chewing gum coating. Perillartine levels in the gum coating may range from 5 ppm to 1000 ppm. The weight of the coating may be about 20% to about 50% of the weight of the finished product.

Conventional panning procedures generally coat with sucrose, but recent advances in panning have allowed use of other carbohydrate materials to be used in place of sucrose. Some of these components include, but are not limited to, dextrose, maltose, palatinose, xylitol, lactitol, hydrogenated isomaltulose, and other new alditols or combinations thereof. These materials may be blended with panning modifiers including, but not limited to, gum arabic, maltodextrins, corn syrup, gelatin, cellulose type materials like carboxymethyl cellulose or hydroxymethyl cellulose, starch and modified starches, vegetable gums like alginates, locust bean gum, guar gum, and gum tragacanth, insoluble carbonates like calcium carbonate or magnesium carbonate and talc. Antitack agents may also be added as panning modifiers, which allow the use of a variety of carbohydrates and sugar alcohols to be used in the development of new panned or coated gum products. Flavors may also be added with the sugar or alditol coating and added with the perillartine sweetener to yield unique product characteristics.

Another type of pan coating would also isolate the perillartine sweetener from the chewing gum ingredients. This technique is referred to as a film coating and is more common in pharmaceuticals than in chewing gum, but procedures are similar. A film like shellac, zein, or cellulose type material is applied onto a pellet-type product forming a thin film on the surface of the product. The film is applied by mixing the polymer, plasticizer and a solvent (pigments are optional) and spraying the mixture onto the pellet surface. This is done in conventional type panning equipment, or in more advanced side-vended coating pans. Because perillartine is alcohol soluble, it may be readily added with this type of film. When a solvent like an alcohol is used, extra precautions are needed to prevent fires and explosions, and specialized equipment must be used.

Some film polymers can use water as the solvent in film coating. Recent advances in polymer research and in film coating technology eliminates the problem associated with the use of solvents in coating. These advances make it possible to apply aqueous films to a pellet or chewing gum product. Perillartine sweetener can be added to this aqueous film solution and applied with the film to the pellet or chewing gum product. The aqueous film or even the alcohol solvent film, which perillartine is highly soluble in, may also contain a flavor along with a polymer and plasticizer. By adding perillartine to the polymer/plasticizer/solvent system, the sweetener can add sweetness to the flavor or a balanced flavor/sweetness can be obtained. The perillartine sweetener can also be dissolved in the aqueous solvent and coated on the surface with the aqueous film. This will give a unique sweetness release to a film-coated product.

The previously described encapsulated, agglomerated, or absorbed high potency sweetener may readily be incorporated into a chewing gum composition. The remainder of the chewing gum ingredients are non-critical to the present invention. That is, the coated particles of the high-potency sweetener can be incorporated into conventional chewing gum formulation in a sugarless chewing gum. However, the high-potency sweeteners may also be used in a sugar chewing gum to intensify and/or extend the sweetness thereof. The coated high-potency sweetener may be used in either regular chewing gum or bubble gum.

In general, a chewing gum composition typically comprises a water-soluble bulk portion, a water insoluble chewable gum base portion and typically water-insoluble flavoring agents. The water-soluble portion dissipates with a portion of the flavoring agent over a period of time during chewing. The gum base portion is retained in the mouth throughout the chew.

The insoluble gum base generally comprises elastomers, resins, fats, and oils, waxes, softeners and inorganic fillers. Elastomers may include polyisobutylene, isobutylene-isoprene copolymer and styrene butadiene rubber, as well as natural latexes such chicle. Resins include polyvinylacetate and terpene resins. Fats and oils may also be included in the gum base, including tallow, hydrogenated and partially hydrogenated vegetable oils, and cocoa butter. Commonly employed waxes include paraffin, microcrystalline waxes such as beeswax and carnauba.

According to the preferred embodiments of the present invention, the insoluble gum base constitutes between about 5 to 95 percent by weight of the gum. More typically, the insoluble gum base may comprise between 10 and 50 percent by weight, and most commonly about 20 and 35 percent by weight of the chewing gum.

The gum base typically also includes a filler component. The filler component may be calcium carbonate, magnesium carbonate, talc, dicalcium phosphate or the like. The filler may constitute between about 5 and 50 percent by weight of gum base.

Gum bases typically also contain softeners, including glycerol monosterate and glycerol triacetate. Further, gum bases may also contain optional ingredients such as antioxidants, colors, and emulsifiers. The present invention contemplates employing any commercially acceptable gum base.

The water-soluble portion of the chewing gum may further comprise softeners, sweeteners, flavoring agents and combinations thereof. Softeners are added to the chewing gum in order to optimize the chewability and mouth feel of the gum. Softeners, also known in the art as plasticizers or plasticizing agents, generally constitute between about 5 to about 15 percent by weight of the chewing gum. Softeners contemplated by the present invention include glycerin, lecithin, and combinations thereof. Further, aqueous sweetener solutions such as those containing sorbitol, hydrogenated starch hydrolysates, corn syrup and combinations thereof may be used as softeners and binding agents in gum.

As mentioned above, the coated high-potency sweeteners of the present invention will most likely be used in sugarless gum formulations. However, formulations containing sugar are also within the scope of the invention. Sugar sweeteners generally include saccharide-containing components commonly known in the chewing gum art which comprise, but are not limited to, sucrose, dextrose, maltose, dextrin, dried invert sugar, fructose, levulose, galactose, corn syrup solids and the like, alone or in any combination.

The coated high-potency sweeteners of the present invention can also be used in combination with other sugarless sweeteners. Generally sugarless sweeteners include components with sweetening characteristics but which are devoid of the commonly known sugars and comprise, but are not limited to, sugar alcohols such as sorbitol, mannitol, xylitol, hydrogenated starch hydrolysates, maltitol and the like, alone or in any combination.

Depending on the particular sweetness release profile and shelf-stability needed, the coated high-potency sweeteners of the present invention can also be used in combination with uncoated high-potency sweeteners or with high-potency sweeteners coated with other materials and by other techniques.

A flavoring agent may be present in the chewing gum in an amount within the range of about 0.1 to about 15 weight percent or from about 0.5 to about 3 weight percent of the gum. The flavoring agents may comprise essential oils, synthetic flavors, or mixtures thereof including, but not limited to, oils derived from plants and fruits such as citrus oils, fruit essences, peppermint oil, spearmint oil, clove oil, oil of wintergreen, anise, and the like. Artificial flavoring components are also contemplated for use in gums of the present invention. Those skilled in the art will recognize that natural and artificial flavoring agents may be combined in any sensorally acceptable blend. All such flavors and flavor blends are contemplated by the present invention.

Optional ingredients such as colors, emulsifiers, and pharmaceutical agents may be added to chewing gum.

In general, chewing gum is manufactured by sequentially adding the various chewing gum ingredients to a commercially available mixer known in the art. After the ingredients have been thoroughly mixed, the gum mass is discharged from the mixer and shaped into the desired form such as by rolling into sheets and cutting into sticks, extruding into chunks or casting into pellets.

Generally, the ingredients are mixed by first melting the gum base and adding it to the running mixer. The base may also be melted in the mixer itself. Color or emulsifiers may also be added at this time. A softener such as glycerin may also be added at this time, along with syrup and a portion of the bulking agent. Further portions of the bulking agent may then be added to the mixer. A flavoring agent is typically added with the final portion of the bulking agent. The coated sweetener of the present invention is preferably added after the final portion of the bulking agent and flavor have been added.

The entire mixing procedure typically takes from 5 to 15 minutes, but longer mixing times may sometimes be required. Those skilled in the art will recognize that many variations of the above-described procedure may be followed.

The following are examples of the invention and comparative examples are provided by way of explanation and illustration.

The formulas listed in Table 1 comprise various sugar-free formulas in which perillartine can be added to gum after it is dissolved in various aqueous solvents.

TABLE 1

| | Example 1 | Example 2 | Example 3 | Example 4 |
|---|---|---|---|---|
| Gum Base | 19.25 | 19.25 | 19.25 | 19.25 |
| Sorbitol | 50.125 | 49.95 | 49.15 | 48.27 |
| Mannitol | 8.00 | 8.00 | 8.00 | 8.88 |
| Hydrogenated Starch | 12.90 | 12.90 | 12.90 | 12.90 |
| Hydrolysate | | | | |
| Glycerin | 8.40 | 8.40 | 8.40 | 8.40 |
| Lecithin | 0.25 | 0.25 | 0.25 | 0.25 |
| Peppermint Flavor | 1.00 | 1.00 | 1.00 | 1.00 |
| Color | 0.05 | 0.05 | 0.05 | 0.05 |
| Liquid/Perillartine | 0.025 | 0.20 | 1.00 | 1.00 |
| Blend | | | | |
| Total | 100.00% | 100.00% | 100.00% | 100.00% |

### EXAMPLE 1

Perillartine powder (99%) can be added directly to the gum.

### EXAMPLE 2

A 2.5 g portion of perillartine can be dissolved in 97.5 g food grade alcohol, making a 2.5% solution and added to gum.

### EXAMPLE 3

A 1.0 g portion of perillartine can be dissolved in 99.0 g mint oil, making a 1.0% solution, and added to gum.

### EXAMPLE 4

A 1.0 g portion of perillartine can be dissolved in 99.0 g propylene glycol, making a 1.0% solution, and added to gum.

In the next examples of sugar gum formulations, perillartine can be mixed in water and emulsifiers to form a suspension. Example solutions can be prepared by dissolving 1.0 g of perillartine in 84.0 g of hot water and adding (except in Example 1) 15.0 g of emulsifiers of various hydrophilic-lipophilic balance (HLB) values to the solution. The mixtures can then be used in the following formulas.

TABLE 2

| | Example 6 | Example 7 | Example 8 | Example 9 | Example 10 |
|---|---|---|---|---|---|
| Sugar | 55.46 | 55.46 | 55.46 | 55.46 | 55.46 |
| Gum | 18.29 | 18.29 | 18.29 | 18.29 | 18.29 |
| Base | | | | | |
| Corn | 13.33 | 13.33 | 13.33 | 13.33 | 13.33 |
| Syrup | | | | | |
| Glycerin | 1.02 | 1.02 | 1.02 | 1.02 | 1.02 |
| Dextrose | 9.90 | 9.90 | 9.90 | 9.90 | 9.90 |
| Mono- | | | | | |
| hydrate | | | | | |
| Pep- | 1.00 | 1.00 | 1.00 | 1.00 | 1.00 |
| permint | | | | | |
| Flavor | | | | | |
| Peril- | 1.00 | 1.00 | 1.00 | 1.00 | 1.00 |
| lartine/ | | | | | |
| *Emul- | | | | | |
| sifier/ | | | | | |
| Water | | | | | |
| Mixture | | | | | |
| | 100.00% | 100.00% | 100.00% | 100.00% | 100.00% |
| *Emul- | None | HLB=2 | HLB=4 | HLB=6 | HLB=9 |
| sifier | | | | | |

Examples 11-15, the same formulations made in 6-10, respectively, except that the flavor can be mixed together with aqueous sweetener solution and emulsified before adding the mixture to the gum batch.

Perillartine sweetener can also be blended into various base ingredients. A typical base is as follows:

| | Wt. % |
|---|---|
| Polyvinyl Acetate | 29.00 |
| Synthetic Rubber | 15.00 |
| Paraffin Wax | 11.00 |
| Fat | 2.00 |
| Glycerol Monosterate | 6.00 |
| Terpene Resin | 25.00 |
| Calcium Carbonate Filler | 12.00 |
| | 100.00% |

The individual base components can be softened prior to their addition in the base manufacturing process. To the presoftened base component, perillartine can be added and mixed, then the presoftened base/sweetener blend can be added to make the finished base. In the following examples, perillartine can be mixed first with one of the base ingredients, and the mixed ingredient can then be used in making the base. The ingredients blended with perillartine can then be used at the levels indicated in the typical base formula above.

### EXAMPLE 16

The terpene resin used to make the base is 99.8% polyterpene resin and 0.2% perillartine.

### EXAMPLE 17

The polyvinyl acetate used to make the base is 99.85% low M.W. polyvinyl acetate and 0.15% perillartine.

### EXAMPLE 18

The paraffin wax used to make the base is 99.95% paraffin wax and 0.05% perillartine.

Perillartine may also be added to an otherwise complete gum base.

### EXAMPLE 19

0.05% perillartine can be mixed with 99.95% of a gum base having the above listed typical formula. The perillartine can be added near the end of the process after all of the ingredients are added.

The samples of finished base made with perillartine added to different base components can then be evaluated in a sugar-type chewing gum formulated as follows:

TABLE 3
(Wt. %)
(For samples 16, 17, 18, and 19)

| | |
|---|---|
| Sugar | 54.05 |
| Base | 20.22 |
| Corn Syrup | 13.73 |
| Glycerin | 1.80 |
| Dextrose Monohydrate | 9.00 |
| Peppermint Flavor | 1.20 |
| | 100.00% |

The theoretical level of perillartine sweetener is 0.01% in the finished gum.

Using the following formulation of sugar-free gum, a variety of encapsulated perillartine samples can be evaluated.

TABLE 4

| | (Wt. %) |
|---|---|
| Sorbitol | 51.20 |
| Mannitol | 7.80 |
| Gum Base | 23.59 |
| Glycerin | 9.00 |
| Hydrogenated Starch Hydrolysate | 6.50 |
| Lecithin | 0.30 |
| Peppermint Flavor | 1.10 |
| Color | 0.50 |
| Active Perillartine | 0.01 |
| | 100.00% |

For spray drying, the solids level of an aqueous or alcoholic solution can be about 10-50%.

### EXAMPLE 20

A 90% shellac, 10% active perillartine powder mixture is obtained by spray drying an alcohol/shellac/perillartine solution at total solids of 10%.

### EXAMPLE 21

A 65% zein, 35% active perillartine powder mixture is obtained by spray drying alcohol/zein/perillartine solution at 20% solids.

### EXAMPLE 22

A 70% shellac, 30% active perillartine powder mixture is obtained by fluid-bed coating perillartine with alcohol/shellac solution of 20% solids.

### EXAMPLE 23

An 80% wax, 20% active perillartine powder mixture is obtained by spray-chilling a mixture of molten wax and perillartine.

### EXAMPLE 24

A 60% zein, 40% active perillartine powder mixture is obtained by spray drying a mixture of perillartine and zein suspended in a high pH (pH of 11.5-12.0) media at 10% solids.

### EXAMPLE 25

A 30% zein, 70% active perillartine powder mixture is obtained by fluid-bed coating perillartine with a high pH (11.5-12.0) zein suspension of 10% solids.

Examples 20-25 would all give nearly complete encapsulation and would delay the release of perillartine sweetener when used in the sugarless gum formulation in Table 4. The higher the levels of coating, or multiple coatings, would give a longer delayed release of sweetener than lower levels of coating.

### EXAMPLE 26

A 90% gelatin, 10% active perillartine powder mixture is obtained by spray drying an aqueous suspension of perillartine and gelatin at 10% solids.

### EXAMPLE 27

A 40% hydroxypropylmethylcellulose (HPMC), 60% active perillartine powder mixture is obtained by fluid-bed coating perillartine with a suspension at 10% solids.

### EXAMPLE 28

A 40% maltodextrin, 60% active perillartine powder mixture is obtained by fluid-bed coating perillartine with a suspension of perillartine and maltodextrin at 20% solids.

### EXAMPLE 29

A 50% gum arabic, 50% active perillartine powder mixture is obtained by spray drying suspension of perillartine and gum arabic at 20% solids.

The coated perillartine in Examples 26 and 27, when used in the chewing gum formula from Table 4, might give a delayed release or fast release of sweetener. However, this delayed release would not be extended as in the previous examples (20-25), but might show some delayed release or fast release. The product coated with maltodextrin and gum arabic in Examples 28 and 29, when used in the gum formula from Table 4, would show a fast release of sweetener in chewing gum compared to perillartine added directly.

Perillartine could also be used as an agglomerated sweetener to give modified sweetness release. Agglomerated sweeteners can be prepared as in the following examples:

### EXAMPLE 30

A 10% gelatin, 90% active perillartine powder mixture is made by agglomerating perillartine and gelatin blended together, with water being added, the resulting product being dried and ground.

### EXAMPLE 31

A 10% hydroxypropylmethyl cellulose (HPMC), 90% active perillartine powder mixture is prepared by agglomerating perillartine and HPMC blended together, with water added, and the resulting product being dried and ground.

### EXAMPLE 32

A 20% shellac, 80% active perillartine powder mixture is made by agglomerating perillartine with an alcohol solution containing 20% shellac, and drying and grinding the resulting product.

### EXAMPLE 33

A 15% wax, 85% active perillartine powder mixture is obtained by agglomerating a blend of perillartine and molten wax, and cooling and grinding the resulting product.

All of the above mixtures can be added to any of the following types of chewing gum formulas:

TABLE 5
(Wt. %)

| | | | | Sugarless | |
|---|---|---|---|---|---|
| | | | | With | |
| | | | | Hydro- | |
| | | | | genated | |
| | | Sugar | Sugarless | Starch | |
| | | With | With | Hydro- | Sugarless |
| | Sugar | Sorbitol | Water | lysate | No Water |
| Gum Base | 20.30 | 20.30 | 28.20 | 28.20 | 28.20 |
| Sugar | 57.595 | 54.095 | — | — | — |
| Sorbitol | — | 3.50 | 52.975 | 50.50 | 50.50 |
| Mannitol | — | — | 7.40 | 7.40 | 7.40 |
| CornSyrup | 11.90 | 11.90 | — | — | — |
| Hydro- | — | — | 8.50 (a) | 5.80 (b) | — |
| genated | | | | | |
| Starch | | | | | |
| Hydrolysate/ | | | | | |
| Sorbitol | | | | | |
| Liquid | | | | | |
| Glycerin | 1.20 | 1.20 | 1.60 | 6.725 | 12.525 |
| Lecithin | — | — | 0.30 | 0.35 | 0.35 |
| Dextrose | 8.00 | 8.00 | — | — | — |
| Monohydrate | | | | | |
| Flavor | 1.00 | 1.00 | 1.00 | 1.00 | 1.00 |
| Level of | 0.005 | 0.005 | 0.025 | 0.025 | 0.025 |
| Active | | | | | |
| Perillartine | | | | | |
| | 100.00% | 100.00% | 100.00% | 100.00% | 100.00% |

(a) liquid sorbitol (70% sorbitol, 30% water)
(b) hydrogenated starch hydrolysate syrup (85% solids)

If each of the examples of agglomerated material (30-33) were evaluated in the formulations shown in Table 5, all samples would give perillartine a modified release. Samples using shellac and wax would give a slower release rate, whereas samples with HPMC and gelatin would give a fast release rate.

Partially coated or fully coated perillartine can also be used in sugar type gum formulations containing other sugars, such as the following formulations A-E.

TABLE 6
(Wt. %)

| | A | B | C | D | E |
|---|---|---|---|---|---|
| Gum Base | 20.20 | 20.20 | 20.20 | 20.20 | 20.20 |
| Sugar | 58.325 | 52.15 | 51.325 | 50.325 | 57.50 |
| Glycerin | 1.20 | 1.20 | 1.20 | 1.20 | 1.20 |
| Corn Syrup | 19.00 | 21.175 | 19.00 | 16.00 | 15.825 |
| Dextrose | — | — | 4.00 | — | — |
| Lactose | — | — | — | — | 4.00 |
| Fructose | — | — | 3.00 | — | — |
| Invert Sugar | — | — | — | 11.00 | — |
| Corn Syrup | — | 4.00 | — | — | — |
| Solids | | | | | |
| Peppermint | 1.25 | 1.25 | 1.25 | 1.25 | 1.25 |
| Flavor | | | | | |
| Level of | 0.025 | 0.025 | 0.025 | 0.025 | 0.025 |
| Perillartine | | | | | |
| | 100.00% | 100.00% | 100.00% | 100.00% | 100.00% |

These formulations may also contain sugar alcohols such as sorbitol, mannitol, xylitol, lactitol, maltitol, hydrogenated isomaltulose, and hydrogenated starch hydrolysates or combinations thereof. Sugarless type gum formulations with partially coated or fully coated perillartine can also be made using various sugar alcohols, such as the following formulations F-J:

TABLE 7
(Wt. %)

| | F | G | H | I | J |
|---|---|---|---|---|---|
| Base | 25.50 | 25.50 | 25.50 | 25.50 | 25.50 |
| Sorbitol | 52.975 | 49.225 | 47.225 | 50.00 | 48.225 |
| Sorbitol | 18.00 | 14.00 | 7.00 | — | 5.00 (a) |
| Liquid/ | | | | | |
| Hydro- | | | | | |
| genated | | | | | |
| Starch | | | | | |
| Hydrolysate | | | | | |
| Mannitol | — | 8.00 | 8.00 | 6.00 | 8.00 |
| Maltitol | — | — | — | 4.00 | — |
| Xylitol | — | — | 9.00 | 11.225 | — |
| Palatinit | — | — | — | — | 10.00 |
| Glycerin | 2.00 | 2.00 | 2.00 | 2.00 | 2.00 |
| Flavor | 1.50 | 1.25 | 1.25 | 1.25 | 1.25 |
| Level of | 0.025 | 0.025 | 0.025 | 0.025 | 0.025 |
| Perillartine | | | | | |
| | 100.00% | 100.00% | 100.00% | 100.00% | 100.00% |

(a) hydrogenated starch hydrolysate (85% solids), all other use sorbitol liquid.

All of these formulations in Table 6 and Table 7 which use agglomerated perillartine as described in samples (30-33) and in the previous (26-29) would be expected to give a fast release of sweetness compares to a product made by adding perillartine directly to gum as a powder.

Multiple step agglomeration/encapsulation procedures can also be used in making release-modified sweeteners for use in the formulations in Tables 5, 6, and 7. Examples of multiple step treatments are here described:

### EXAMPLE 34

Perillartine spray dried with maltodextrin at 15% solids to prepare a powder. This powder is then agglomerated with hydroxypropylmethyl cellulose (HPMC) in a ratio of 85/15 powder/HPMC, wetted with water and dried. After grinding the resulting powder will contain about 68% active perillartine, 17% maltodextrin, and 15% HPMC.

### EXAMPLE 35

Perillartine is agglomerated with HPMC in a ratio of 85/15 sweetener/HPMC. After drying and grinding, the resulting powder is agglomerated with a 15% solids, high pH, aqueous solution of zein to give a final product containing about 60% active perillartine, 10% HPMC, and 30% zein.

### EXAMPLE 36

Perillartine is spray dried with a 20% solution of gelatin. The spray-dried product is then agglomerated with 15% solids, high pH, and aqueous solution of zein. The final product will contain about 50% active perillartine, 20% gelatin, and 30% zein.

### EXAMPLE 40

Perillartine is agglomerated with molten wax in a ratio of 85/15 sweetener/wax. When the mixture cools and is ground, it is fluid-bed coated with a 20% zein-80% alcohol solution, giving a final product containing 60% active perillartine, 10% wax, and 30% zein.

These examples 34-40, when used in any of the formulations noted in Tables 5, 6, and 7 above, give perillartine a modified release or modified sweetness. These multiple step procedures can actually give more delayed release then the single step processes. Multiple processes of more than two steps may give even longer delayed release times, but generally become less cost effective and less efficient. Spray drying can be the first step, with additional steps of fluid-bed coating, spray chilling, and agglomeration being part of the latter steps.

For absorption type examples, modified release of perillartine sweetener is dependent on the type of absorbing material. Most materials like silicas, silicates, cellulose, carbonates, and hydroxides would be expected to give a delayed release compared to amorphous sugar and sugar alcohols, which would give a modified release. Some examples:

### EXAMPLE 41

A hot 5% solution of perillartine is sprayed onto a precipitated silica to absorb the sweetener. The mixture is dried and coated with fumed silica. The final product is about 35% active perillartine.

### EXAMPLE 42

A hot 5% solution of perillartine is sprayed onto a high absorption starch to absorb sweetener. The mixture is dried and ground and gives a product that is about 90% starch and 10% perillartine.

### EXAMPLE 43

A hot 5% solution of perillartine is sprayed onto a calcium carbonate powder to absorb the sweetener. The mixture is dried and ground and gives the product about 95% calcium carbonate and 5% perillartine.

### EXAMPLE 44

A hot 1% solution of perillartine is sprayed onto a sorbitol powder to absorb the material. The mixture is dried and ground and gives a product of about 99% sorbitol and 1% perillartine.

The samples prepared in Examples 41-44 can be used in gum formulations as noted in Tables 5, 6, and 7. Those preparations, which have perillartine absorbed onto a material that is water-soluble, are expected to give a delayed response of perillartine sweetener. Those preparations having perillartine absorbed onto water-soluble materials are expected to give a modified release.

Another absorption technique is to dry the perillartine together with a sugar or sugar alcohol, or resolidify the sweetener with sugar or sugar alcohol, after both are mixed together in a molten state.

Many of the examples listed are single step processes. However, a more delayed release of the perillartine sweetener may be obtained by combining the various processes of encapsulation, agglomeration, absorption, and entrapment. Any of the preparations made in Examples 41-44 can be further treated in fluid-bed coating, spray-chilling, or coacervation processes to encapsulate the product, and can be agglomerated with various materials and procedures in a variety of multiple step processes.

The perillartine sweetener may also be used with a variety of other high-intensity sweeteners and blended together before encapsulation, agglomeration, absorption, and entrapment. Some examples are:

### EXAMPLE 45

Perillartine and alitame in a 1/1 ratio are prepared in a hot 5% solution. This solution is sprayed onto a high absorption silica powder. The mixture is dried, ground and fluid-bed coated with an alcohol/shellac mixture, giving a product that contains 25% perillartine, 25% alitame, 35% silica and 15% shellac.

### EXAMPLE 46

Perillartine and sodium cyclamate in a 1/5 ratio are blended together as a powder and then agglomerated with water and hydroxypropylmethyl cellulose (HPMC). This blend is dried, ground and agglomerated further with a high pH, aqueous 15% solution of zein to obtain a product containing 50% sodium cyclamate, 10% perillartine, 15% HPMC, and 25% zein.

### EXAMPLE 47

Sucralose and perillartine in a 3/1 ratio are blended together as a powder and fluid-bed coated with a solution of 30% shellac in alcohol. The coated product is agglomerated further with water and hydroxypropylmethyl cellulose (HPMC) to obtain a product containing 45% sucralose, 15% perillartine, 25% shellac, and 15% HPMC.

If the blends of perillartine and other high-intensity sweeteners of Examples 45-47 are tested in gum formulations such as those noted in Tables 4, 5, 6, and 7, a significant modified release of the sweetener and sweetness should be expected. Due to the synergistic effects of some of the sweetener combinations in Examples 45-47, less total sweetener can be used to give the same sweetness level as the single delayed release perillartine sweetener.

Perillartine may also be combined with other high intensity sweeteners without encapsulation, agglomeration, or absorption and used in chewing gum, as in the following examples:

### EXAMPLE 48

A combination of perillartine and aspartame can be used in the formulas listed in Tables 5, 6, and 7 by adjusting the formulas to contain 0.025% perillartine and 0.05% aspartame.

### EXAMPLE 49

A combination of perillartine and acesulfame K can be used in formulas listed in Tables 5, 6, and 7 by adjusting the formulas to contain 0.025% perillartine and 0.05% acesulfame K.

### EXAMPLE 50

A combination of perillartine and sodium saccharin can be used in the formulas listed in Tables 5, 6, and 7 by adjusting the formulas to contain 0.025% perillartine and 0.05% sodium saccharin.

These formulations of Examples 48-50 may give a delayed release for those sweeteners, which normally have a slow release. Some of these sweetener combinations may be synergistic, in which case less total sweetener may be needed to give the same sweetness level as a single sweetener.

It should be appreciated that the methods and compositions of the present invention are capable of being incorporated in the form of a variety of embodiments, only a few of which have been illustrated and described above. The invention may be embodied in other forms without departing from its spirit or essential characteristics. It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. However, the described embodiments are to be considered in all respects only as illustrative and not restrictive, and the scope of the invention is, therefore, indicated by the appended claims rather than by the foregoing description. All changes that come within the meaning and range of equivalency of the claims are to be embraced within their scope.

We claim:

1. A method of producing a chewing gum product containing physically-modified perillartine in order to modify the release of perillartine in the mouth comprising the steps of:
a) mixing a quantity of perillartine with a modifying agent to produce a physically-modified perillartine;
b) adding a quantity of the physically-modified perillartine to a chewing gum composition to provide a level of perillartine in gum of from about 1 ppm to about 5000 ppm.

2. The method of claim 1 wherein said modifying agent is an encapsulating agent.

3. The method of claim 2 wherein the perillartine and encapsulating agent are also mixed with a solvent and the resulting mixture is dried prior to being added to the chewing gum composition.

4. The method of claim 3 wherein the encapsulating material is selected from the group consisting of maltodextrin, gum arabic, zein and shellac.

5. The method of claim 3 wherein the mixture is spray dried and the solvent is selected from the group consisting of alcohol and water.

6. A chewing gum made according to the method of claim 3.

7. The method according to claim 2 wherein the perillartine is fluid-bed coated with a solution of encapsulating agent and solvent in order to modify the release of perillartine in a chewing gum composition.

8. The method of claim 7 wherein the solvent is selected from the group consisting of alcohol and water.

9. The method of claim 7 wherein the encapsulating material is selected from the group consisting of shellac and zein.

10. A chewing gum made according to the method of claim 7.

11. The method according to claim 2 wherein the perillartine is encapsulated by coacervation in order to modify the release of perillartine in the chewing gum composition.

12. The method of claim 2 wherein the perillartine is mixed with a molten encapsulating agent and the perillartine is encapsulated by spray chilling in order to modify the release of the perillartine in a chewing gum composition.

13. The method of claim 12 wherein the encapsulating agent comprises wax.

14. The method of claim 2 wherein the perillartine is mixed with a polymer as the encapsulating agent and the resulting mixture is extruded into fine fibers in such a way as to encapsulate the perillartine in order to modify the release of the perillartine in the chewing gum composition.

15. The method of claim 14 wherein the polymers are selected from the group consisting of PVAC, hydroxypropyl cellulose, polyethylene and plastic polymers.

16. The method of claim 1 wherein the perillartine is mixed with an absorbent as the modifying agent.

17. A method of producing a chewing gum containing physically-modified perillartine in order to modify the release of perillartine comprising the steps of:
a) mixing a quantity of perillartine with an agglomerating agent and a solvent to partially coat the perillartine;
b) removing the solvent from the mixture of perillartine and agglomerating agent to form a dried material; and
c) adding a quantity of the dried material to a chewing gum coating to provide a perillartine level in gum of from about 50 to about 5000 ppm.

18. The method of claim 17 wherein the level of coating on the agglomerated perillartine is at least about 5%.

19. The method of claim 17 wherein the level of coating on the agglomerated perillartine is at least about 15%.

20. The method of claim 17 wherein the level of coating on the agglomerated perillartine is at least about 20%.

21. The method of claim 17 wherein the dried material is ground to a powder prior to adding the dried material to the chewing gum.

22. The method of claim 1 wherein perillartine which has not been treated with a modifying agent is also added to the chewing gum composition.

23. A chewing gum product comprising a chewing gum composition formed into a piece of chewing gum having a rolling compound thereon, the rolling compound comprising perillartine.

24. A liquid-filled chewing gum product wherein the liquid fill comprises perillartine.

25. A coated chewing gum product comprising a gum pellet coated with a coating, the coating comprising perillartine.

26. The coated chewing gum product of claim 25 wherein the coating comprises a hard shell coating.

27. The coated chewing gum product of claim 25 wherein the perillartine comprises about 10 ppm to about 2000 ppm by weight of the chewing gum product.

28. A method of making a coated chewing gum product comprising the steps of:
a) providing chewing gum product cores;
b) providing a coating solution; and
c) coating the chewing gum product cores with the coating solution to provide coated chewing gum products, the coating including perillartine.

29. The method of claim 28 wherein the perillartine is mixed into the coating solution prior to coating the cores.

30. The method of claim 28 wherein the coating operation includes the application of multiple coats of coating solution and application of powder material between coats of coating solution.

31. The method of claim 30 wherein the perillartine is included in the powder material.

32. The method of claim 30 wherein the perillartine is included in both the coating solution and the powder material.

33. The method of claim 28 wherein at least two different coating solutions are used to make the coating.

34. The method of claim 33 wherein the perillartine is mixed with the first of the at least two different coating solutions and applied to form a film, and a second coating solution is applied over the film coated cores.

35. The method of claim 28 wherein the perillartine is present in the coating at a level of about 10 ppm to about 2000 ppm by weight of the chewing gum product.
